(19) United States
(12) Patent Application Publication
(10) Pub. No.: US 2010/0270106 A1
(43) Pub. Date: Oct. 28, 2010

(54) SECURING DEVICE FOR EXTENDING LADDER

(76) Inventor: MEI-HUA CHEN, Kaohsiung City (TW)

Correspondence Address: PHILLIP LIU, 6980, WHITEOAK DRIVE, RICHMOND, BC, V7E 4Z9, CA

(21) Appl. No.: 12/730,986

(22) Filed: Mar. 24, 2010

Related U.S. Application Data
(63) Continuation-in-part of application No. 11/372,012, filed on Mar. 10, 2006, now abandoned.

(51) Int. Cl. E06C 1/12; E06C 7/08; E06C 7/06

(52) U.S. Cl. 182/195

(57) ABSTRACT

A ladder is composed of a plurality of rung units and each unit includes two hollow tubes and a rung connected between the two hollow tubes. The hollow tubes of the rung units have gradually reduced outer diameters so that the hollow tubes can be telescopically received to form a compact size. The rung is connected to the two hollow tubes of each rung unit by two connectors and each connector includes two buttons which can be pushed in the direction perpendicular to the axis of the rung to release the interlock connection between the rung and the hollow tubes so as to easily collapse or extend the ladder.

The present invention is a Continuation-In-Part application of U.S. patent Ser. No. 11/372,012, filed on Mar. 10, 2006.

### FIELD OF THE INVENTION

### Background of the Invention

A conventional ladder includes two columns which are usually parallel to each other and rungs are connected between the two columns. The rungs are fixed to the columns so that the ladder is bulky and inconvenient for storage. Three extending ladders are known to applicant and disclosed in U.S. Pat. No. 6,708,800, U.S. Pat. No. 1,828,152, and U.S. Pat. No. 6,883,645.

U.S. Pat. No. 6,708,800 discloses a button 182 which is exposed on an outside of the rung 108 and is operated to move along the longitudinal direction of the rung 108. It is obvious that the exposed button can easily be stepped by the heel portion of the user's shoes. Because the button 182 is designed to be pushed along the rung, not in the direction perpendicular to the axis of rungs, the button is easily deformed or the shoulder bolt or rod 507 connected to the button as shown in FIG. 10 is easily broken. Once the button is deformed or the bolt or rod is deformed or cracks, the function to move the pin 184 will be failed. The exposed button 182 can be easily pushed unintentionally by the user of the ladder when his or her foot steps on the button 182 or when grasping the rung, his or her hand may push the button 182. Also, persons passing by the ladder or a tool box of the persons may push the button 182. Besides, the force applied to the button has to be changed in directions two times to move the pin and this is not efficient.

Besides, the connection of the first column 104 and the connector 128 is not securely enough because there lacks of tightening means to securely and tightly connect the connector to the column.

The present invention intends to provide a ladder wherein the buttons for releasing the interlocking of the rung units and the connectors are operated by pressing the button in the direction perpendicular to the axis of the rung, and the buttons are located substantially in flush with the surface of the rungs.

### SUMMARY OF THE INVENTION

The present invention relates to a ladder which comprises two parallel columns and each column is composed of a plurality of hollow tubes which have gradually reduced outer diameter so that the tubes with small sizes can be telescopically receivable in the tubes with large sizes. Each tube has an upper hole and a lower hole. Each pair of the tubes have a rung connected therebetween and two connectors are connected between two ends of the rung and the two tubes.

Each connector has a mounting ring mounted on a top end of each tube and, an insertion inserted into one of the two ends of the rung. A connection member is connected between the mounting ring and the insertion. The connection member has a through hole is in alignment with the upper hole and communicates with the insertion and the mounting ring. Each insertion has a controller received therein and the controller including a seat and a button. The seat has a biasing member and a locking bar which is biased by the biasing member at one end thereof. The locking bar is inserted into the through hole of the connection member and the upper hole of the tube. A pin transversely extends through the locking bar. The button has a curved head and two tongues extend from an side of the head and extend into the insertion so as to push the locking bar.

The rung has two apertures defined in a side of two ends thereof and the insertions are inserted into the two ends of the rung so that when the locking bars extend through the through holes of the connectors, the upper holes of the two tubes with large size and the lower holes of the tubes with small size, the ladder is extended and established. When the buttons are pushed, tongues shift the pins such that the locking bars are withdrawn from the lower holes of the tubes with small size, and the tubes with small sizes are telescopically received in the tubes of large sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ladder wherein the hollow tubes are telescopically received each other;

FIG. 2 is a cross sectional view to show a part of the hollow tubes telescopically received each other;

FIG. 3 is an exploded view to show the connectors for connecting the rung and two hollow tubes;

FIG. 4 is an enlarged exploded view to show the connectors for connecting the rung and two hollow tubes;

FIG. 5 is a perspective view to show the connector of the present invention;

FIG. 6 is a top view of the connector of the present invention;

FIG. 7 is a cross sectional view along line A-A in FIG. 6;

FIG. 8 shows a cross sectional view of the connection of the connector and the rung and the hollow tube, wherein the button is not yet pushed;

FIG. 9 is a cross sectional view along line B-B in FIG. 8;

FIG. 10 shows a cross sectional view of the connection of the connector and the rung and the hollow tube, wherein the button is pushed;

FIG. 11 is a cross sectional view along line C-C in FIG. 10;

FIG. 12 is a cross sectional view to show the positions of the locking bars when the tubes are pulled up, and

FIG. 13 is a cross sectional view to show the positions of the locking bars when the tubes telescopically received in each other.

### DETAILED DESCRIPTION OF THE PREFERRED EMBODIMENT

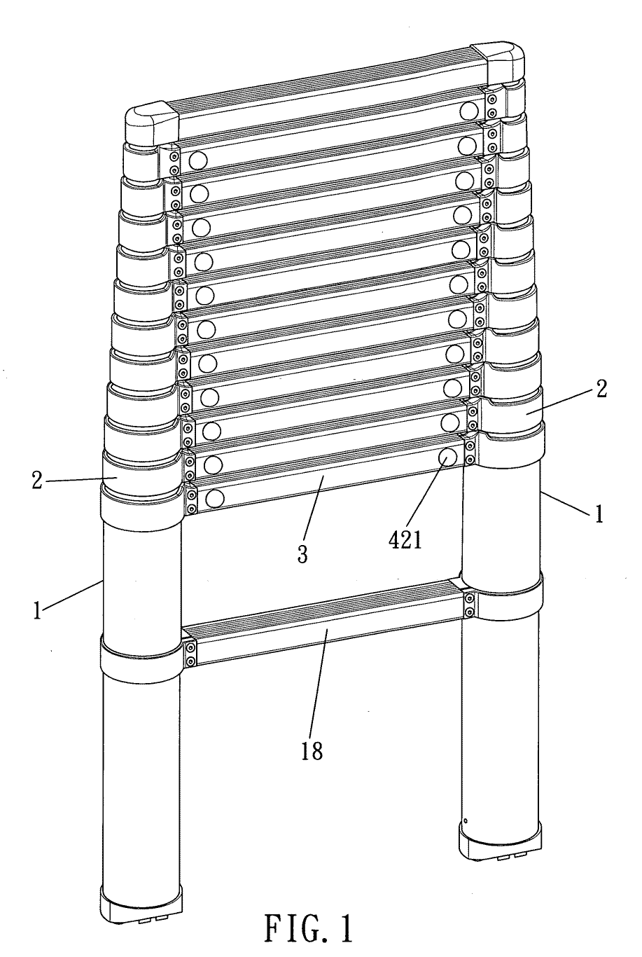

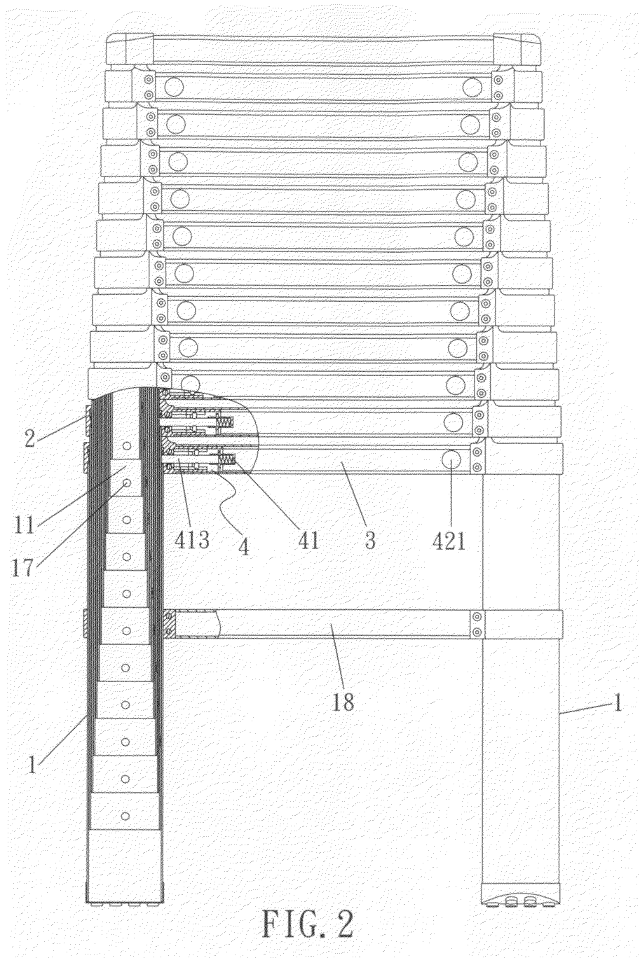

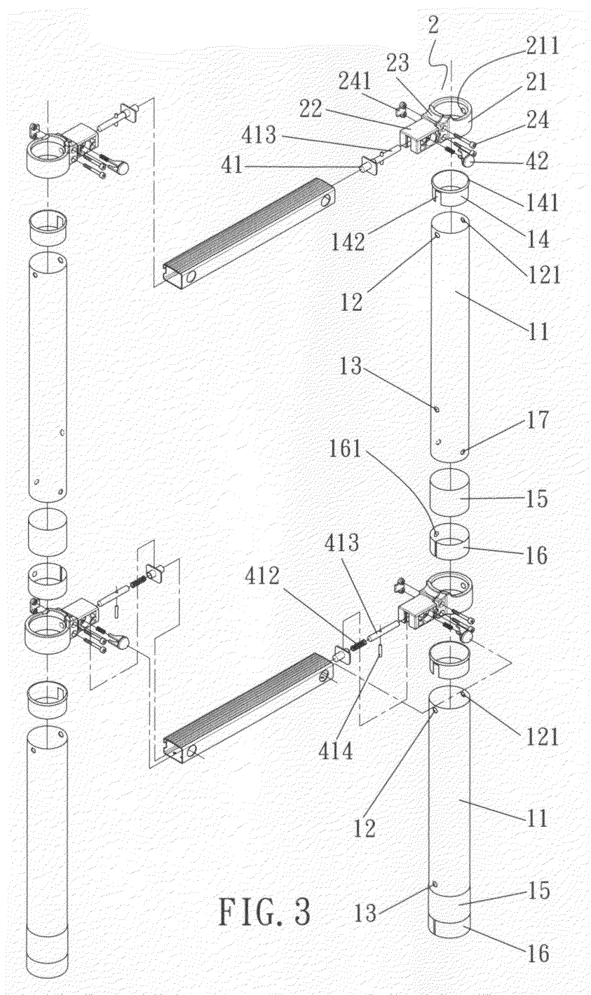

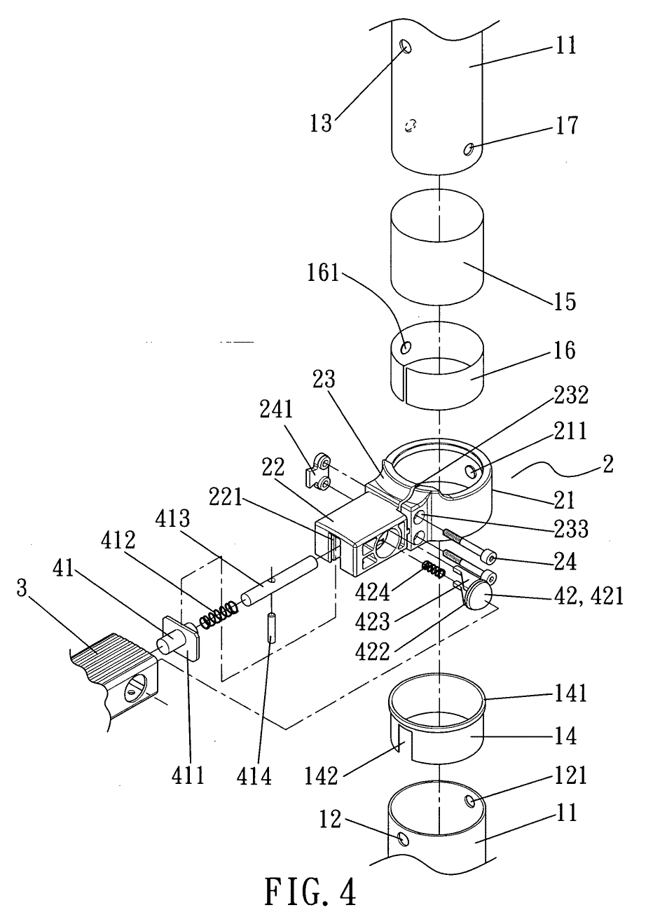

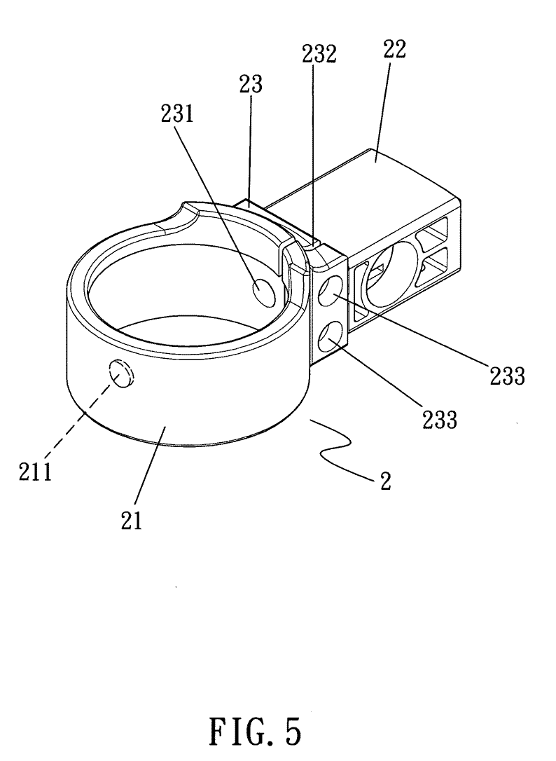

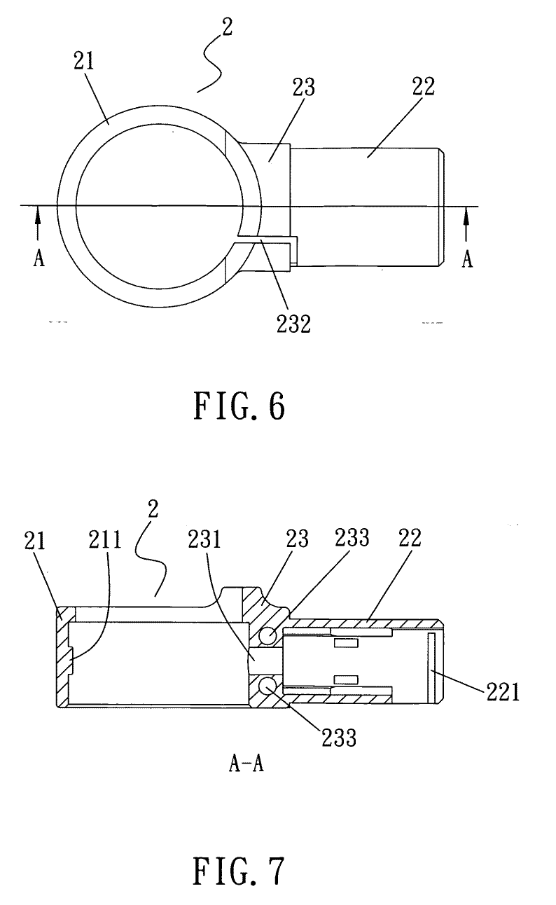

Referring to FIGS. 1 to 7, the ladder of the present invention is composed of composed of a plurality of rung units and each rung unit includes two hollow tubes 11 and a rung 3 connected therebetween. The hollow tubes 11 form two parallel columns 1 and the hollow tubes 11 have gradually reduced outer diameter so that the tubes 11 with small sizes are telescopically receivable in the tubes 11 with large sizes as shown in FIG. 1. Each tube 11 has an upper hole 12 and a lower hole 13 defined through a wall of two ends thereof, and the upper holes 12 and the lower holes 13 in the two respective tubes 11 face each other. Two connectors 2 are connected between two ends of the rung 3 and the two tubes 11. A separation bar 18 is connected between the two tubes 11 with largest sizes to keep a stable width between the two columns 1.

Each connector 2 has a mounting ring 21 and an insertion 22, wherein the mounting ring 21 is mounted on a top end of each tube 11 and the insertion 22 is inserted into one of the two ends of the rung 3. A connection member 23 is connected between the mounting ring 21 and the insertion 22. A through hole 231 is defined in the connection member 23 and in alignment with the upper hole 12 so as to communicate with the insertion 22 and the mounting ring 21. The connection member 23 has an L-shaped slot 232 which communicates with the mounting ring 21. Two passages 233 are defined through the connection member 23 such that the through hole 231 is located between the two passages 233. Two bolts 24 extend through the passages 233 and are connected to a reinforcement plate 241 so that the mounting ring 21 is fixed on the tube 11. Each of the tubes 11 has a positioning hole 121 located close to the top end thereof and the mounting ring 21 has a positioning protrusion 211 extending from an inner periphery thereof so that the positioning protrusion 211 is engaged with the positioning hole 121.

It is noted that each of the tubes 11 has an inner bush 14 inserted in a top end thereof and the inner bush 14 has a flange 141 extending radially outward therefrom so as to be positioned between the mounting ring 21 and the tube 11. The inner bush 14 has a notch 142 which is in alignment with the upper hole 12. Each of the tubes 11 has an outer bush 15 and an outer collar 16 mounted to an outer periphery of a lower end of the tube 11. The outer bush 15 and the outer collar 16 are located between the tube 11 with small size and the tube 11 with large size, and do not block the lower hole 13. Each of the tubes 11 has an engaging hole 17 defined through a wall of the lower end thereof and the outer bush 16 has a boss 161 extending from an inner periphery thereof. The boss 161 is engaged with the engaging hole 17 such that the outer bush 16 is fixed on the tube 11.

Each insertion 22 has a controller 4 received therein and the controller 4 includes a seat 41 and a button 42. The seat 41 includes a board 411, a biasing member 412 received in a box on the board 411 and a locking bar 413 which has one end inserted in the box via an open end of the box and is biased by the biasing member 412 at one end thereof. The board 411 can be inserted in a groove 221 defined in an underside of the insertion 22 so as to be securely connected to the insertion 22. The locking bar 413 is inserted into the through hole 231 of the connection member 23 and the upper hole 12 of the tube 11. A pin 414 transversely extends through the locking bar 413.

The button 42 has a curved head 421 which has a stepped surface 422 and two tongues 423 extend from a side of the head 421 and into the insertion 22. Each of the tongues 423 has an inclined section which pushes the pin 414 connected to the locking bar 413 in the direction of the axis of the rung 3 when the button 42 is pushed in the direction perpendicular to the axis of the rung 3. The rung 3 has two apertures 31 defined in a side of two ends thereof and the insertions 22 are inserted into the two ends of the rung 3 and the heads 421 project from the apertures 31. The stepped surface 422 of each button 42 is engaged with an inside of the aperture 31 corresponding thereto.

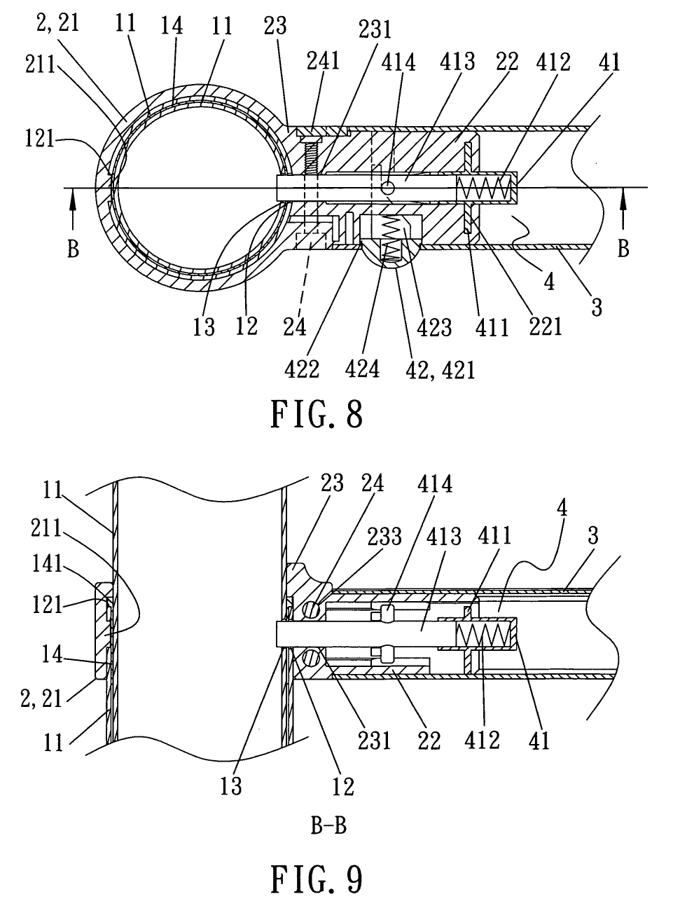

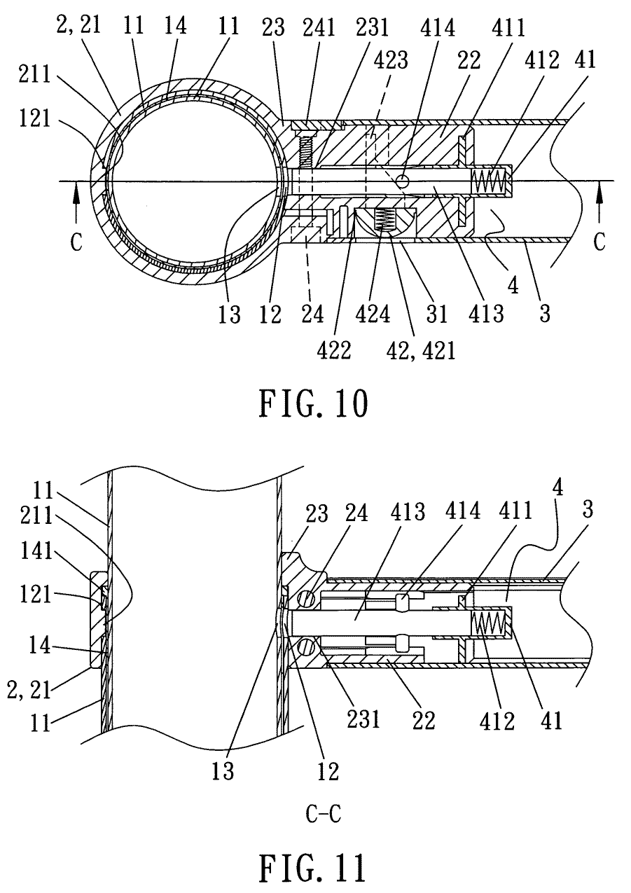

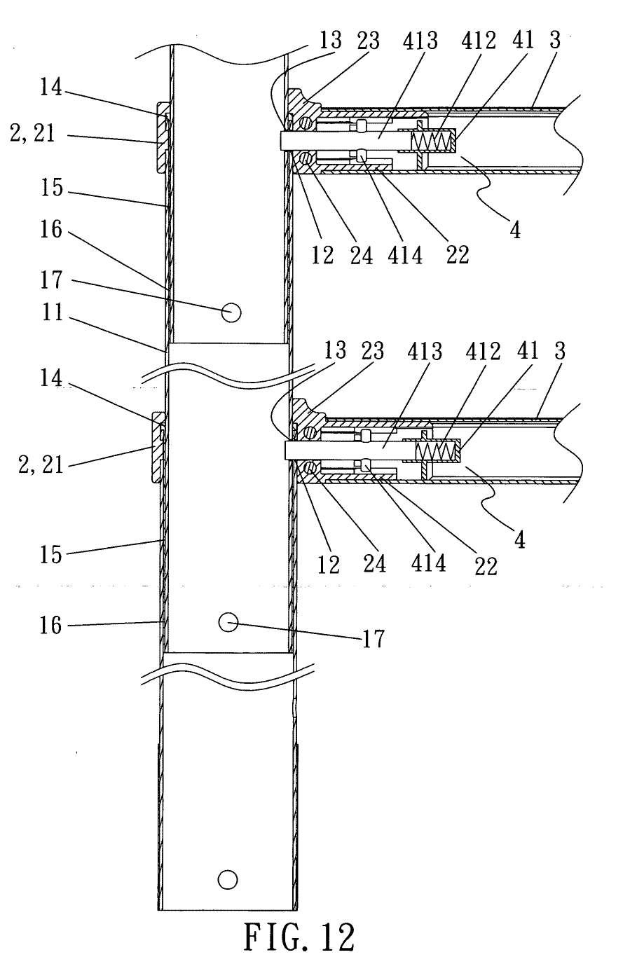

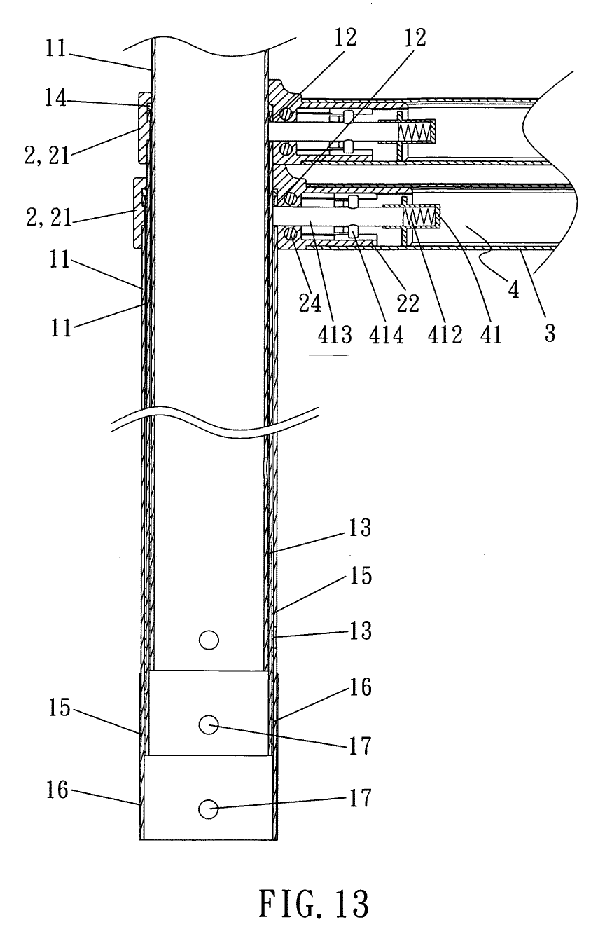

Referring to FIGS. 8-13, when the locking bars 413 extend through the through holes 231 of the connectors 2, the upper holes 12 of the two tubes 11 with large size and the lower holes 13 of the tubes 11 with small size, the ladder is established. On the contrary, when the buttons 42 are pushed in the direction perpendicular to the axis of the rung 3 and the inclined sections of the tongues 423 shift the pins 414, the locking bars 413 are withdrawn from the lower holes 13 of the tubes 11 with small size, the tubes 11 with small sizes are telescopically received in the tubes 11 of large sizes. The button 42 of each controller 4 has a second biasing member 424 received in the head 421 so as to bounce the button 42 back to its original position when releasing the buttons 42.

The ladder can be easily collapsed or extended by pushing the two buttons 42 in the direction perpendicular to the axis of the rung 3 to move the locking bars 413. Because the buttons 42 are substantially in flush of the outside of the rungs 3, and the operational direction of the buttons 42 is perpendicular to the axis of the rungs 3, the buttons 42 are not operated unintentionally in any circumstances, and this is an important safety factor to protect the users.

The tubes 11 can be made by a first material, and the inner bushes 14, the outer bushes 15 and the outer collars 16 can be made by a second material. The first material can be aluminum alloy and the second material can be composite material.

While we have shown and described the embodiment in accordance with the present invention, it should be clear to those skilled in the art that further embodiments may be made without departing from the scope of the present invention.

What is claimed is:

1. A ladder comprising:
two parallel columns and each column composed of a plurality of hollow tubes which have gradually reduced outer diameter so that the tubes with small sizes are telescopically receivable in the tubes with large sizes, each tube having an upper hole and a lower hole defined through a wall of two ends thereof, the upper holes and the lower holes of the tubes of the two columns facing each other, each pair of the tubes having a rung connected therebetween and two connectors connected between two ends of the rung and the two tubes, each of the tubes having an inner bush inserted in a top end thereof and the inner bush having a flange extending radially outward therefrom, the inner bush having a notch which is in alignment with the upper hole;
each connector having a mounting ring mounted on a top end of each tube and the flange being positioned between the mounting ring and the tube, each of the tubes having a positioning hole located close to the top end thereof, the mounting ring having a positioning protrusion extending from an inner periphery thereof, the positioning protrusion engaged with the positioning hole, an insertion inserted into one of the two ends of the rung, a connection member connected between the mounting ring and the insertion, the connection member having a through hole which is in alignment with the upper hole so as to communicate with the insertion and the mounting ring;
the connection member of each of the connectors having an L-shaped slot which communicates with the mounting ring, two passages defined through the connection member such that the through hole is located between the two passages, two bolts extending through the passages and connected to a reinforcement plate so that the mounting ring is fixed on the tube by tightening the two bolts and narrowing the L-shaped slot;
each insertion having a controller received therein and the controller including a seat and a button, the seat having a biasing member and a locking bar which has one end biased by the biasing member, the locking bar inserted into the through hole of the connection member and the upper hole of the tube, a pin transversely extending through the locking bar;
the button having a curved head which has a stepped surface, two tongues extending from an side of the head and extending into the insertion and each tongue having an inclined section, the button being pressed in a direction perpendicular to an axis of the rung corresponding thereto so as to push the pin connected to the locking bar along the axis of the rung, and
the rung having two apertures defined in a side of two ends thereof, the insertions being inserted into the two ends of the rung and the heads projecting from the apertures, the stepped surface of each button being engaged with an inside of the aperture corresponding thereto so as to prevent the button from disengaging from the aperture corresponding thereto.

2. The ladder as claimed in claim 1, wherein each of the tubes has an outer bush and an outer collar mounted to an outer periphery of a lower end of the tube, the outer bush and the outer collar are located between the tube with small size and the tube with large size, and do not block the lower hole.

3. The ladder as claimed in claim 3, wherein each of the tubes has an engaging hole defined through a wall of the lower end thereof and the outer bush has a boss extending from an inner periphery thereof, the boss is engaged with the engaging hole such that the outer bush is fixed on the tube.

4. The ladder as claimed in claim 1, wherein the button of each controller has a second biasing member received in the head so as to bounce the button back to its original position.

5. The ladder as claimed in claim 1, wherein a separation bar is connected between the two tubes with largest sizes.

6. The ladder as claimed in claim 1, wherein the tubes are made by a first material, the inner bushes, the outer bushes and the outer collars are made by a second material.

7. The ladder as claimed in claim 6, wherein the first material is aluminum alloy and the second material is composite material.

8. The ladder as claimed in claim 1, wherein the seat includes a board which has a box with an open end and the biasing member is received in the box, the end of the locking bar is inserted into the box via the open end and biased by the biasing member.

9. The ladder as claimed in claim 8, wherein a groove is defined in an underside of the insertion and the board is inserted in the groove.
